(19) United States
(12) Patent Application Publication
(10) Pub. No.: US 2012/0119121 A1
(43) Pub. Date: May 17, 2012

(54) APPARATUS FOR REGULATING A VOLUME FLOW IN A HOSE

(75) Inventors: Hans-Juergen Hopf, Zirndorf (DE); Alexander Hopf, Nuernberg (DE); Michael Hopf, Zirndorf (DE)

(73) Assignee: Hans-Juergen HOPF, Zirndorf (DE)

(21) Appl. No.: 13/318,307

(22) PCT Filed: Mar. 29, 2010
(86) PCT No.: PCT/EP2010/054120

§ 371 Date: Jan. 19, 2012

(30) Foreign Application Priority Data
Apr. 30, 2009 (DE) 20 2009 004 772.5

(51) Int. Cl. F16K 51/00

(52) U.S. Cl. 251/4

(57) ABSTRACT

A clamp for regulating a volume flow in a plastic hose, having a housing for receiving the plastic hose having a predetermined flow cross-section and a wheel which is accommodated in a guide so as to be displaceably along a longitudinal direction. The plastic hose is arranged between the circumferential contour of the wheel and an inner surface of the housing such that in a first position of the wheel, the flow cross-section of the plastic hose is opened to the maximum, and in a second position the flow cross-section is closed in a fluid-tight manner. The housing is formed by a cover and a base, arranged displaceably in a direction relative to each other to enable the plastic hose to be inserted there between.

The present invention relates to a device for regulating a volume flow in a hose, preferably in a plastic hose, as is used in medical technology for example.

Devices for regulating the volume flow in a hose are known in the prior art. Such devices are preferably used in medical technology for the administration of infusions or transfusions and for artificial nutrition, in which case these devices, when used for such purposes, are referred to as infusion, transfusion or transfer systems or kits. In addition to the device for regulating the volume flow, these infusion or transfusion kits also comprise other components, which serve in particular to connect an infusion container to an intra-arterial, intravenous or intra-osseous access. Thus, for example, an infusion kit comprises a spike, which is used to pierce a rubber stopper on the infusion container, a drip chamber, a plastic hose, which can be designed for example as a transparent infusion line, the device for regulating the volume flow, and a connector piece for connecting the kit to an access, for example a peripheral venous catheter.

In the known devices for regulating a volume flow in a hose for use in medical technology, the volume flow is preferably regulated by changing the cross section of the hose through the interaction of a roller body with an inner surface of a housing. In a completely opened state of the device, a maximum volume flow is permitted, and, in a closed position, in which the cross section of the hose is completely reduced by squeezing, there is consequently no volume flow inside the hose.

However, the device known in the prior art for regulating a volume flow in a hose for use in medical technology has the disadvantage that, among other things, the device has to be made available pre-assembled with the infusion or transfusion kit, and it is not possible, if the need arises, to remove the device from the corresponding kit. However, this may be necessary in particular if the infusion or transfusion kit is not being used on its own, but together with an infusion pump, for example, with which volumetrically precise metered quantities can be predefined and guaranteed via a corresponding controlling and metering system.

The object of the present invention is to at least partially remedy the disadvantages known in the prior art concerning the use and the design of devices for regulating a volume flow in a hose for use in medical technology.

The following object is achieved by a clamp according to the invention for regulating a volume flow in a plastic hose in accordance with claim 1. Preferred alternative embodiments of the invention are the subject matter of the dependent claims.

According to the invention, the device or clamp for regulating a volume flow in a plastic hose comprises a housing which accommodates, along with at least one plastic hose with a predetermined flow cross section, a wheel received in a longitudinally displaceable manner in a guide in the housing. In particular the wheel, the plastic hose and at least an inner surface of the housing are arranged in such a way that, in at least a first position of the wheel in relation to the housing, the flow cross section of the plastic hose is opened to the maximum, and, in at least a second position of the wheel in relation to the housing, the flow cross section of the plastic hose is closed in a fluid-tight manner at least in some parts. The device according to the invention is characterized in that the housing is preferably designed in two parts and is formed in particular by a cover and a base. The cover and the base are designed in such a way that at least one of these components has a substantially U-shaped cross section, and the two components are preferably longitudinally displaceable relative to each other in such a way that, in the separated position of the two components, the interior of the housing is freed at least for the insertion of the plastic hose.

According to another particularly preferred embodiment of the device according to the invention, the plastic hose is in particular a flexible or highly flexible plastic hose which is preferably transparent and, according to another particularly preferred embodiment, has a clear internal diameter of preferably between 0.2 mm and 10 mm.

According to another particularly preferred embodiment, the wheel, received longitudinally displaceably in a guide of the housing, is designed with a predetermined circumferential cross section and is mounted rotatably in a guide of the housing by means of two shaft portions.

According to another particularly preferred embodiment, the guide for the wheel is designed in particular as a ramp and preferably has the shape of a longitudinal groove. The longitudinal groove is preferably arranged in the inner area of the housing, the longitudinal extent of the housing being defined by the main directional extent thereof along which the plastic hose is also substantially arranged during operation.

According to another particularly preferred embodiment, the guide, which is arranged inside the housing, is designed such that, depending on the mean wheel diameter and on the clear inside width of the housing, it spaces the wheel in the first position so far apart from the inner wall of the housing that the flow cross section of the plastic hose is completely freed. Moreover, at least in a second position of the wheel, the flow cross section is closed, in particular by means of the plastic hose being squeezed between the inner wall of the housing and the circumferential contour of the wheel, such that at least in this portion there is no volume flow inside the plastic hose, and the latter is thus closed in a fluid-tight manner.

According to another particularly preferred embodiment, the flow cross section of the hose can be changed in steps between the opened position and the closed position of the wheel in relation to the housing, and, according to another particularly preferred embodiment, the areas in which complete closure or complete opening of the flow cross section is possible are not limited only to individual points but are ensured over larger adjustment ranges.

According to another particularly preferred embodiment of the present invention, particularly when the housing is in the assembled state for operation, the cover and the base of the housing are connected to each other with a force fit by a guide, particularly a linear guide. Such a guide can be in particular a flat guide, a prismatic guide, a dovetail guide or a trapezoid guide, which serves in particular to prevent inadvertent separation of the two components during operation.

Flat guides have the advantage that they are easy to work and have a high degree of stiffness. To ensure that the guide can function smoothly, a so-called narrow guide has to be used. This is characterized in that the lateral guide has to be very narrow in order at least to prevent jamming.

Prismatic guides are derived from a triangle shape and guide the components in two directions, such that additional narrow guides can be omitted. The best design solution is to be seen in the prismatic flat guide, which is statically defined. Under the effect of heat, the components are able to expand transversely with respect to the direction of movement, without distortion occurring.

The dovetail guide is another type of guide that can be derived from the triangle shape. This type of guide requires only four guide surfaces and can therefore be made relatively small. In view of the modern production machinery and processes available today, the required degrees of precision no longer pose a problem.

According to another particularly preferred embodiment, inadvertent separation of the two components, that is to say accidental opening of the cover from the base of the housing, can be avoided by additional safety means. For this purpose, it is possible in particular to use a catch, a locking pin, a clip, a tapering of the guide in the end area for the purpose of clamping the cover to the base, a snap-fit connection emitting in particular an acoustic signal, combinations of these and the like.

According to another particularly preferred embodiment, a safety means can be provided in such a way that a housing, once it has been assembled, can subsequently be opened only by destroying the housing. Another alternative embodiment comprises a safety means which, while in particular ensuring repeated closing and opening of the two components, nevertheless avoids inadvertent opening or movement of the cover relative to the base.

According to another particularly preferred embodiment of the present invention, the wheel in particular is preferably pre-assembled inside the guide groove in the base of the housing.

According to another particularly preferred embodiment, the circumferential contour of the wheel has a fluting that is preferably oriented at a predetermined angle with respect to the rotation axis.

According to another particularly preferred embodiment, at least the housing, individual components of the housing or the safety means is/are made of a plastic chosen from a group that preferably comprises thermosetting plastic and thermoplastic, in particular polyphenylene sulfide, polypropylene, poly-1-butene, polyvinyl chloride, polyvinylidene chloride, polymethyl methacrylate, polyacrylonitrile, polystyrene, polyacetal, polyvinyl alcohol, polyvinyl acetate, ionomers, fluoroplastic, polyethylene, polyamide, in particular a partially aromatic polyamide, polycarbonate, polyester, polyphenylene oxide, polysulfone, polyvinyl acetal, polyurethane, and chlorinated polyether, cellulose nitrate, cellulose acetate, cellulose ether, phenolic resin, urea resin, thiourea resin, melamine resin, alkyl resin, allyl resin, silicone, polyimide, polybenzimidazole, epoxy resin, casein plastic, crosslinked polyurethane, unsaturated polyester resin, combinations of these and similar.

In addition, at least the housing, the wheel and/or the safety means is produced by injection molding.

According to another particularly preferred embodiment of the present invention, the clamping force in particular for squeezing the plastic hose in the closed position is such that this force has a value of between N and 400 N and preferably provides a fluid tightness of the plastic hose that is maintained even at a fluid pressure in the plastic hose of between 0.1 bar and 8 bar.

Another particular advantage of the present invention lies in the use of the clamp in transfusion and enteral and parenteral infusion and in the use with tube feed systems, pump transfer systems, gravity infusions and transfer systems in general. In addition, another advantage is that, particularly in the use of integrated clamp systems or in the use of pumps, the subsequent fitting of the clamp according to the invention makes available a device with which influence can also be exerted subsequently on the volume flow in a hose, for example if the pump fails or the integrated clamp is defective.

The invention is disclosed below on the basis of various illustrative embodiments. It is expressly noted that the present invention is not limited by the illustrative embodiments set out below, and that these are instead only possible illustrative embodiments, from which a person skilled in the art will know that modifications and refinements going beyond these may also lie within the meaning of the present invention.

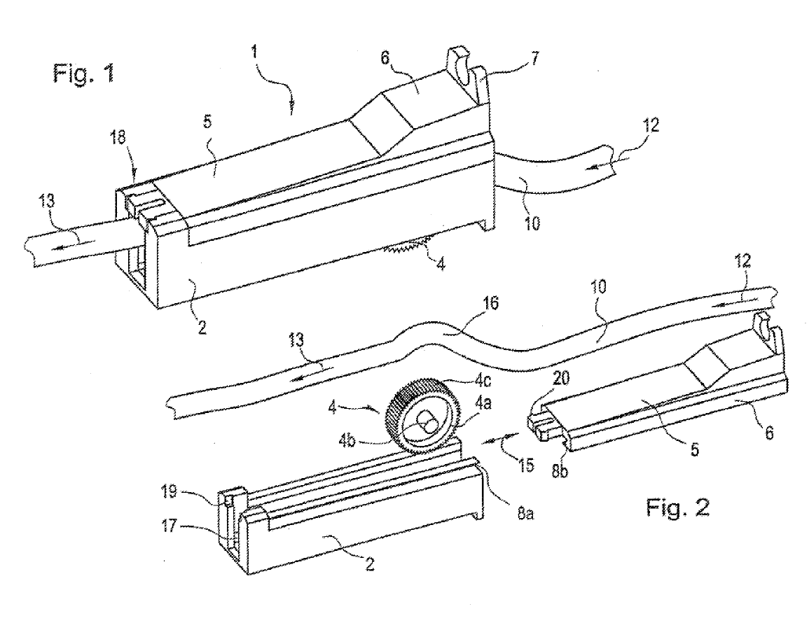

FIG. 1 shows a perspective side view of the assembled device for regulating a volume flow in a medical hose.

FIG. 2 shows a perspective exploded view of the device for regulating a volume flow.

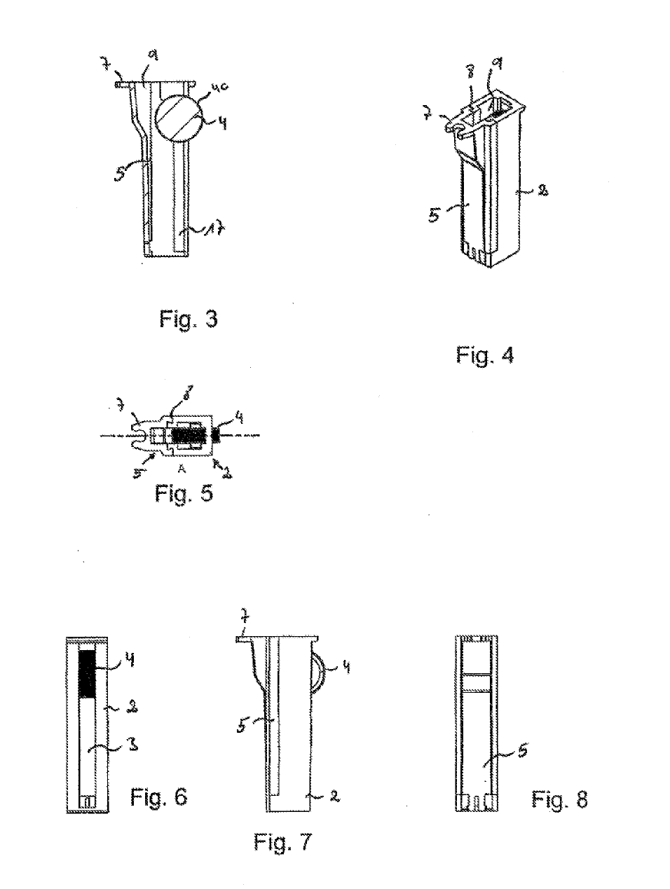

FIG. 3 shows a longitudinal section through the device for regulating a volume flow.

FIG. 4 shows a perspective side view of the device for regulating a volume flow, without the hose.

FIG. 5 shows a plan view of the device for regulating a volume flow along a hose along from FIG. 3.

FIGS. 6 to 8 show side views of the device according to FIG. 4.

FIG. 1 is a perspective side view of an assembled device for regulating a volume flow, with the hose 10 already assembled in a functional state in the housing with the cover 5, the base 2 and the wheel 4. In addition to the individual components, the view also shows details of the design.

FIGS. 6 to 8 are side views of the embodiment according to FIG. 3 for illustrating a possible configuration or device according to the invention.

In relation to the housing 1, the base 2 can be seen with a longitudinal recess 3 through which access is afforded to the operator for the adjustment.

The upper area on the right shows the elevation for the “open position” of the device which, toward the left, by means of the inner side of the housing coming toward the outer contour of the wheel 4, leads to the desired squeezing of the hose 10, with a fluid-tight closure of the hose 10.

Reference sign 7 denotes a fixing means for the hose 10 in which, in particular when the preparation for an infusion has been completed, the attachment area of the hose can be secured to the access for example for a peripheral venous catheter, in order to avoid the corresponding area hanging down and possibly being contaminated. Reference signs 12 and 13 denote the preferred direction of flow of the fluid inside the plastic hose 10. Reference sign 18 indicates a safety means by which inadvertent movement of the cover 5 from the base 2 is avoided.

FIG. 2 is a perspective exploded view of the embodiment according to FIG. 1, once again depicting, along with the hose 10, also the housing 1 with its base 2, the cover 5 and the wheel 4. The view also makes clear how, according to the embodiment shown here, the connection between the cover 5 and the base 2 is afforded by a dovetail guide 8a and 8b. The engagement of the dovetail tongue 8a in the dovetail groove 8b is obtained by a sliding movement along the directional arrow 15. The wheel 4 with its base 4a and with the rotation shaft 4b has, on its circumferential surface, a fluting 4c that permits improved operation and also a more or less strong linear compressive force on the hose 10, particularly in the closed position. In the assembled state, the rotation shaft 4b is received in the groove 17 of the base 2. The hose 10 shown in FIG. 2 corresponds, in the illustration given here, to the profile thereof in a functional state, with the portion 16 indicating that the hose 10 substantially adapts to the outer radius of the wheel 4. Moreover, FIG. 2 indicates the structure acting as safety means which, according to the embodiment shown here, is made up of a two-sided hook 20 in the cover 5 and of catch recesses 19 in the base 2.

FIG. 3 is a longitudinal section through the device from FIG. 1. In this drawing, it can be clearly seen that the opened position, that is to say the area in which the flow cross section of the plastic hose 10 is not substantially changed by the wheel 4 and is thus completely opened, is provided at the top, whereas in the lower area the hose is closed by being squeezed between the outer contour 4c of the wheel 4 and the inner contour of the cover 5. The wheel 4 is received with its rotation shaft 4b in the groove 17, which defines the guide along a predetermined path of travel.

In the embodiment shown here, it is also clear that the inner contour of the cover 5 moves closer to the groove 17 substantially along the longitudinal extent from the top downward, such that the desired, almost continuous reduction of the flow cross section of the plastic hose is made available from the top downward with the movement of the wheel.

FIG. 4 is a perspective view of the device according to FIG. 3 for illustrating the outer contour of the housing.

FIG. 5 is a plan view of the device according to FIG. 3, this view showing how the wheel 4 is arranged in relation to the inner contour in the open position. The dovetail guide 8 can also be seen.

FIGS. 6 to 8 are side views of FIG. 4 for illustrating the outer structure of the embodiment shown here.

1. A clamp for regulating a volume flow in a plastic hose, said clamp comprising a housing, for receiving the plastic hose with a predetermined flow cross section, and a wheel, which is received in a longitudinally displaceable manner in a guide in the housing, wherein the plastic hose is arranged between the circumferential contour of the wheel and at least one portion of an inner surface of the housing in such a way that, in at least a first position of the wheel in relation to the housing, the flow cross section of the plastic hose is opened to the maximum, and, in at least a second position of the wheel in relation to the housing, the flow cross section is closed in a fluid-tight manner at least in some parts, wherein the housing is formed by a cover and a base, at least the cover and/or the base having a U-shaped cross section and being displaceable relative to each other in such a way that, in the separated position, the interior of the housing is freed at least for the insertion of the plastic hose.

2. The clamp as claimed in claim 1, wherein the plastic hose is in particular a flexible plastic hose having a clear internal diameter of between 0.2 mm and 10 mm.

3. The clamp as claimed in claim 1, wherein the wheel with a predetermined circumferential cross section is mounted rotatably in the guide of the housing by means of two shaft portions.

4. The clamp as claimed in claim 3, wherein the guide is designed as a ramp inside the housing and preferably has the shape of a longitudinal groove.

5. The clamp as claimed in claim 3, wherein the guide, depending on the mean wheel diameter and on the clear inside width of the housing, spaces the wheel in the first position so far apart from the relevant inner wall of the housing that the flow cross section of the plastic hose is completely freed, and, in at least the second position, the flow cross section is closed in a fluid-tight manner by means of the plastic hose being squeezed between the inner wall of the housing and the circumferential contour of the wheel.

6. The clamp as claimed in claim 3, wherein the flow cross section of the plastic hose changes in steps, via the position of the wheel, from the opened position to the closed position.

7. The clamp as claimed in claim 1, wherein the cover and the base of the housing are connected to each other by a guide, in particular by a longitudinally arranged flat guide, prismatic guide, dovetail guide or trapezoid guide.

8. The clamp as claimed in claim 1, wherein a safety means is provided between the base and the cover of the housing and prevents inadvertent opening or movement of the cover or of the base, such a safety means comprising in particular a catch, a locking pin, a clip, a tapering of the groove in the end area for the purpose of clamping the cover to the base, a snap-fit connection emitting in particular an acoustic signal, combinations of these and/or similar.

9. The clamp as claimed in claim 1, wherein the wheel is preferably pre-assembled in the base.

10. The clamp as claimed in claim 1, wherein the circumferential contour of the wheel has a fluting that is oriented at a predetermined angle with respect to the rotation axis.

11. The clamp as claimed in claim 1, wherein at least the housing is made of a plastic chosen from a group that preferably comprises thermosetting plastic and thermoplastic, and in particular polyphenylene sulfide, polypropylene, poly-1-butene, polyvinyl chloride, polyvinylidene chloride, polymethyl methacrylate, polyacrylonitrile, polystyrene, polyacetal, polyvinyl alcohol, polyvinyl acetate, ionomers, fluoroplastic, polyethylene, polyamide, in particular a partially aromatic polyamide, polycarbonate, polyester, polyphenylene oxide, polysulfone, polyvinyl acetal, polyurethane, and chlorinated polyether, cellulose nitrate, cellulose acetate, cellulose ether, phenolic resin, urea resin, thiourea resin, melamine resin, alkyl resin, allyl resin, silicone, polyimide, polybenzimidazole, epoxy resin, casein plastic, crosslinked polyurethane, unsaturated polyester resin, combinations of these and similar.

12. The clamp as claimed in claim 1, wherein the clamp, individual components thereof, for example the wheel and/or the housing, is produced by injection molding.

13. The clamp as claimed in claim 1, wherein the clamping force for squeezing the plastic hose in the closed position has a value of between 10 N and 400 N and preferably ensures the fluid tightness at a fluid pressure in the plastic hose of between 0.1 bar and 8 bar.
